(19) United States
(12) Patent Application Publication
(10) Pub. No.: US 2004/0181562 A1
(43) Pub. Date: Sep. 16, 2004

(54) System and method for determining deallocatable memory in a heap

(76) Inventor: Piotr Findeisen, Plano, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/389,151

(22) Filed: Mar. 13, 2003

(51) Int. Cl. G06F 17/30; G06F 12/00

(52) U.S. Cl. 707/206

(57) ABSTRACT

A system and method for determining deallocatable memory in a heap that includes a plurality of referenced objects. In one embodiment, the method includes determining a subset of objects based on a predetermined criterion and determining the amount of deallocatable memory associated with objects of the subset.

### CROSS-REFERENCE TO RELATED APPLICATION(S)

This application discloses subject matter related to the subject matter disclosed in the following commonly owned co-pending patent application: “SYSTEM AND METHOD FOR OPTIMIZING MEMORY USAGE BY LOCATING LINGERING OBJECTS,” filed ______, Ser. No.: ______ (Docket Number 200208718-1), in the name of Piotr Findeisen, incorporated by reference herein.

### BACKGROUND

Object oriented programming is a well-known software application development technique that employs collections of objects or discrete modular data structures that are identified by so called references. More than one reference can identify the same object. The references can be stored in the application variables and within the objects, forming a network of objects and references, known as the reference graph. The objects are created dynamically during the application execution, and are contained in a memory structure referred to as a heap.

Many object oriented programming languages, such as Java, Eiffel, and C sharp (C#), employ automatic memory management, popularly known as garbage collection. Automatic memory management is an active component of the runtime system associated with the implementation of the object oriented language, which removes unneeded objects from the heap during the application execution. An object is unneeded if the application will no longer use it during its execution. A common way of determining at least a substantial subset of the unneeded objects is to determine so called “liveness” of all objects in the heap. An object is defined as “live” if there exists a path of references starting from one of the application variables, and ending at the reference to the given object. A path of references is defined as a sequence of references in which each reference with the exception of the first reference in the sequence is contained within the object identified by the previous reference in the sequence.

A frequent problem appearing in object oriented applications written in languages with automatic memory management is that some objects due to the design or coding errors remain live, contrary to the programmer's intentions. Such objects are called lingering objects. Lingering objects tend to accumulate over time, clogging the heap and causing multiple performance problems, eventually leading to the application crash.

To detect the lingering objects, programmers in the development phase of the application life-cycle employ memory debugging or memory profiling tools. In one widely practiced debugging methodology, the tool produces a heap dump which serves as a baseline snapshot that illustrates the objects residing in the heap at the given time. A set of test inputs is then run through the program and the tool produces a second snapshot of the heap which illustrates the objects residing in the heap at the second time. The programmer then compares the two snapshots to determine which objects are accumulating over time. By analyzing the reference graphs contained in the heap dumps, and using his/her skills and the knowledge of the program logic, the programmer can determine which objects are lingering, and, what is even more important, why they stay alive. Then the programmer can proceed with fixing the application program in such a way that no more reference paths to the lingering objects can be found by the garbage collector.

Despite the acceptance of the existing approaches to finding lingering objects and optimizing the memory usage of software applications, they are computationally intensive and do not easily scale in production environments. For instance, known methodologies employed to calculate the amount of memory held by an object, i.e. deallocatable memory, use a simulated garbage collection technique that may have a quadratic complexity of O(N*K), wherein N is the number of all references in the heap and K is the number of objects. Applying such techniques to large heaps employed in a transaction-intensive application is practically impossible.

### SUMMARY

A system and method are disclosed for determining deallocatable memory in a heap that includes a plurality of referenced objects. In one embodiment, the method includes determining a subset of objects based on a predetermined criterion and determining the amount of deallocatable memory associated with objects of the subset.

### BRIEF DESCRIPTION OF THE DRAWINGS

FIG. 1 depicts a schematic block diagram illustrating a deallocatable memory engine being employed in a software platform environment;

FIG. 2 depicts a block diagram of one embodiment of a hardware platform which includes a multiprocessing system for supporting the deallocatble memory engine of FIG. 1;

FIG. 3 depicts a flowchart illustrating one embodiment of a method for determining deallocatble memory in a heap;

FIG. 4 depicts a flowchart illustrating one embodiment of a method for determining deallocatable memory sizes based on a subset of candidate lingering objects in a heap;

FIG. 5A depicts an exemplary heap prior to the practice of one embodiment of the system for determining a set of candidate lingering objects; and

FIG. 5B depicts the heap exemplified in FIG. 5A following the removal of references cycles from therein.

### DETAILED DESCRIPTION OF THE DRAWINGS

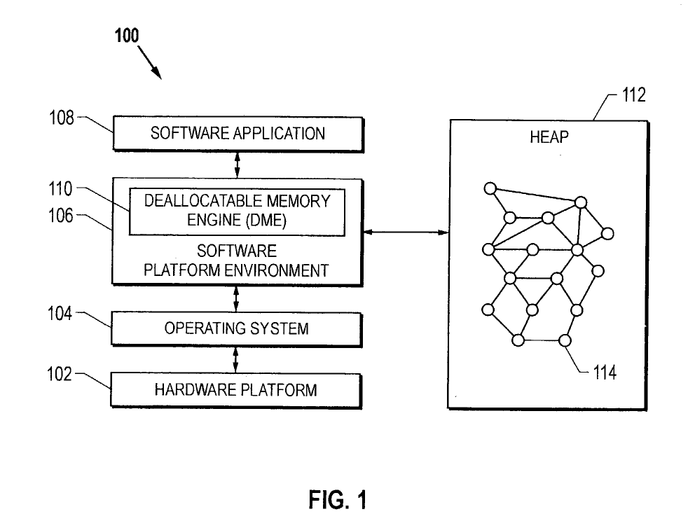

In the drawings, like or similar elements are designated with identical reference numerals throughout the several views thereof, and the various elements depicted are not necessarily drawn to scale. Referring now to FIG. 1, therein is depicted a computer system 100 that effectuates a software platform environment 106 in which a deallocatable memory engine (DME) 110 embodying the teachings described herein is supported. A hardware platform 102 may be a sequential or a parallel processing machine that provides the physical computing machinery on which an operating system (OS) 104 is employed. The OS may be UNIX, HP-UX®, Sun® Solaris®, Windows® NT®, Linux, or other OS that manages the various software and hardware operations of the computer system 100. The software platform environment 106 may be a design/diagnostic tool environment or virtual machine environment, for example.

In the design tool environment, the software platform environment 106 provides the utilities to compile and execute source code of a software application 108, e.g., a target application, in an object oriented programming language and, in particular, in an object oriented language wherein programmers do not explicitly free allocated memory. The target application 108 may be written in Java, Eiffel, C#, or other interpretive language developed for manipulation of symbolic strings and recursive data.

In the virtual machine environment 126, the software platform environment provides an abstraction layer between the OS 104 and the software application 108, e.g., a compiled application, that allows the software application 108 to operate independently of the hardware and software of the system 100. In a further embodiment, a separate diagnostic tool environment having the DME functionality may be provided in association with the virtual machine environment. It should be appreciated that the form and functionality of the software platform environment 106 will vary depending on the computer programing language employed. For example, if the Java programing language is employed, the software platform environment 106 may take the form of a Java virtual machine (JVM).

As depicted, a heap 112 includes objects created pursuant to the execution of the software application 108. These objects may be arranged as a complex mesh of inter-object references, for example, in a reference graph 114 that occupies at least a portion of the heap 112. The heap 112 provides a runtime data area from which memory may be allocated to objects which may be arrays or any class instances such as fields, methods, interfaces, and nested classes. It should be appreciated that the object components will depend on the computer programming language and virtual machine environment employed, for example. The heap 112 may be instantiated by a profiler utility interacting with the executing program after the program has executed long enough to reach a steady state under a representative or target workload. Accordingly, the reference graph 114 includes all of the objects created by an executing program as represented in an inter-referential relationship wherein objects are denoted as circles, with references being line segments or edges therebetween. It will be apparent that an object may refer to no objects, one object, or multiple objects. Via a process referred to as garbage collection, the software platform environment 106 maintains the heap 112 by automatically freeing objects that are no longer referenced by the software application 108. As will be described in further detail hereinbelow, the DME 110 is operable to determine the amount of memory held by the objects in the heap that may be deemed as lingering objects, thereby facilitating the optimization of the target software application's memory usage.

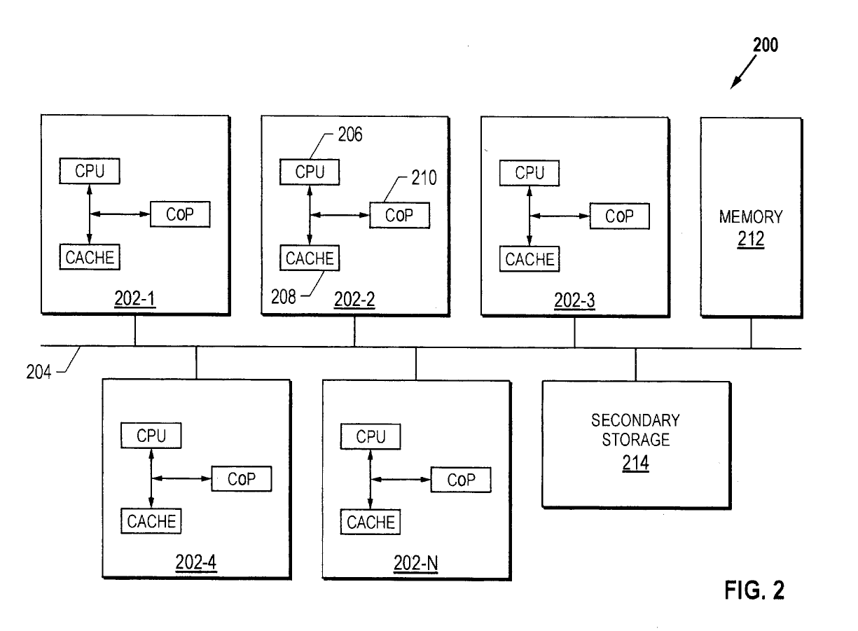

FIG. 2 depicts a hardware platform which includes a multiprocessing (MP) system 200 for supporting the DME of FIG. 1 in one embodiment. Reference numerals 202-1 through 202-N refer to a plurality of processor complexes interconnected together via a high performance, MP-capable bus 204. Each processor complex, e.g., processor complex 202-2, is comprised of a central processing unit (CPU) 206, a cache memory 208, and one or more coprocessors 210. In one implementation, the MP system 200 may be architectured as a tightly coupled symmetrical MP (SMP) system where all processors have uniform access to a main memory 212 and any secondary storage 214 in a shared fashion. As an SMP platform, each processor has equal capability to enable any kernel task to execute on any processor in the system. Whereas threads may be scheduled in parallel fashion to run on more than one processor complex, a single kernel controls all hardware and software in an exemplary implementation of the MP system 200, wherein locking and synchronization strategies provide the kernel the means of controlling MP events.

Continuing to refer to FIG. 2, each processor complex may be provided with its own data structures, including run queues, counters, time-of-day information, notion of current process(es) and priority. Global data structures, e.g., heaps, available for the entire MP system 200 may be protected by means such as semaphores and spinlocks, and may be supported by secondary storage 214. Furthermore, in other implementations of the MP system, the processors can be arranged as “cells” wherein each cell is comprised of a select number of processors (e.g., 4 processors), interrupts, registers and other resources such as, e.g., Input/Output resources. In a production environment, for example, the MP system 200 may operate as a high-performance, non-stop sever platform for running mission-critical software applications in object oriented languages capable of effectuating a large number of transactions. In such environments, thousands of objects may be created having complex referential relationships that can pose severe constraints on heap usage unless efficiently managed.

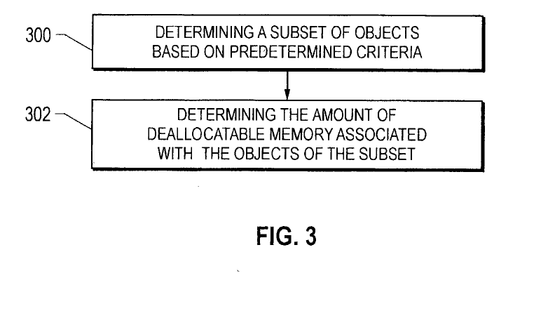

FIG. 3 depicts one embodiment of a method for determining deallocatable memory in an object oriented heap. As discussed, objects created pursuant to executing a software application may be arranged as a complex reference graph of inter-object references. Whereas the conventional techniques determine deallocable memory by performing simulated garbage collection operations on each and every object of a reference graph, thereby incurring a quadratic complexity, an embodiment of the present invention performs simulated garbage collection operations only on a reduced number of objects that are determined by using a “Constrained Bytes Held” function, Bc(t). Throughout the following discussion, the following formal notation will be used:

B(t), i.e., the “Bytes Held” function, represents the number of bytes that can be freed if a particular object t were to be removed from a heap; and

Bc(t) approximates B(t) when t is deemed to be a lingering object, i.e., at least when there is only a select number of references to object t and when the value of B(t) is large.

Accordingly, at block 300, a subset of objects is determined based on one or more predetermined criteria. In one embodiment, the predetermined criteria are designed to efficiently select a subset of objects which have reference relationships and properties that are indicative of a lingering object. For example, if the number of references to an object is within a predetermined range and an estimate of the deallocatable memory, i.e., Bc(t), associated with that object is greater than a threshold value, then the object is deemed to be lingering. Additional details relating to lingering objects may found in the related patent application cross-referenced hereinabove.

At block 302, the amount of deallocatable memory associated with the objects of the subset is determined. In one embodiment, a garbage collection is simulated to determine the amount of deallocatable memory associated with the objects of the subset. The garbage collection may involve temporarily removing the object and nullifying all the references to that particular object. A function B(t) represents the amount of deallocatable memory, which may be expressed as the number of bytes held, that may be freed if a particular object t is removed from the heap. In one implementation, B(t)=S0−S, wherein:

S0 is the size of the heap in bytes; and

S is the size of the heap after temporarily removing the object t, nullifying all the references to the object t, and running a simulated garbage collection.

The garbage collection operation uses a linear algorithm (O(N)) , but it is employed only over a reduced set of the objects within the heap. As will be seen below, the complexity of the method described herein is O(N+K*logK) wherein:

N is the total number of references in the heap;

and K is the number of objects in the heap.

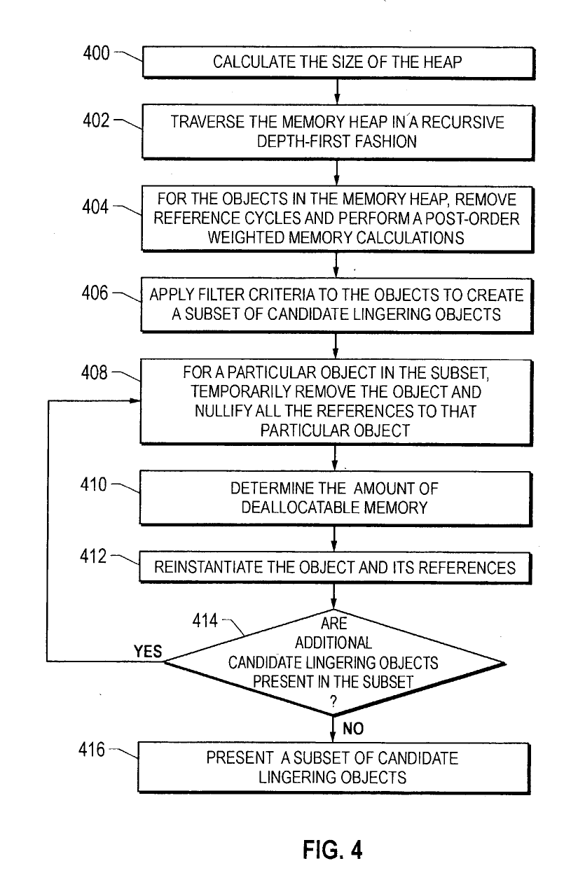

FIG. 4 depicts one embodiment of a method for determining deallocatable memory sizes based on a subset of candidate objects in an object heap. At block 400, the size of the heap, i.e., S0, is calculated. At block 402, the heap is traversed. In one implementation, the heap may be traversed in a recursive depth-first fashion. At block 404, for the objects in the heap, the reference cycles are removed and post-order weighted memory calculations are performed. It should be appreciated, however, that the operations of block 404, i.e., removing the reference cycles and performing the post-order weighted memory calculation, may be performed independently of each other.

The operations of blocks 400-404 represent the calculation of a constrained deallocatable memory function Bc(t) for all of the objects in the heap. As pointed out above, in general, the deallocatable memory function Bc(t) has the following properties:

i) B(t)≦Bc(t) for all objects t belonging to the heap;

ii) Bc(t)≈B(t) when object t has only one reference and the value of B(t) is relatively large with respect to the heap; and

iii) the calculation of the deallocatble memory function Bc(t) for all the objects in the heap has a linear complexity of O(N) where N is the number of references in the heap.

In one embodiment, for an acyclic reference graph, Bc(t) may be computed as follows:

i) if object t is a leaf node, i.e., object t has no outgoing references, then Bc(t)=T where T is the size of node t; or

ii) if object t is not a leaf node and r₁, r₂, . . . , rₘ are the outgoing references of object t, then Bc(t)=T+ΣBc(sⱼ)/eⱼ wherein:

j is number of references (1, 2, . . . , m);

sⱼ is the node pointed to by the reference rj; and

eⱼ is the number of incoming edges to node sⱼ.

Since the heap's object reference graph is acyclic as a result of the operations of block 404, Bc(t) is well-defined as will be illustrated by the example provided hereinbelow.

At block 406, a filter criterion is applied to the objects in order to create a subset of candidate lingering objects. In one embodiment, all the objects t are sorted in decreasing order with respect to Bc(t). In one embodiment, the first L objects t are selected for the subset of candidate lingering objects. In another embodiment, all objects t having a Bc(t) greater than a predetermined “Constrained Bytes Held” metric are selected for the subset of candidate lingering objects. The complexity of determining the subset of candidate objects may be expressed as O(N+K*log(K)) since:

i) calculating Bc(t) has a complexity of O(N); and

ii) applying the filter sorting criterion has a complexity of O(K*log(K)).

At block 408, for a particular object in the subset of candidate lingering objects, the object is temporarily removed and all the references to the object are nullified. At block 410, the amount of deallocatable memory associated with the object is determined, i.e., a simulated garbage collection is executed and the calculation S0−S is performed for the object t. At block 412, the object and its references are reinstantiated. At decision block 414, if additional candidate lingering objects are present in the subset, the method recursively executes operations 408-412, as indicated by the return flow arrow, until all the deallocatable memory held by each of the candidate lingering objects within the set has been determined. Once the deallocatable memory held by each candidate object of the subset has been determined, the method progresses to operation 416 wherein the set of candidate lingering objects is presented. The candidate lingering objects may be subsequently deallocated automatically or the subset may be presented to a programmer or end user in the form of a menu, such as a reference graph tree menu, to allow the programmer or end user to judge which objects should be deallocated.

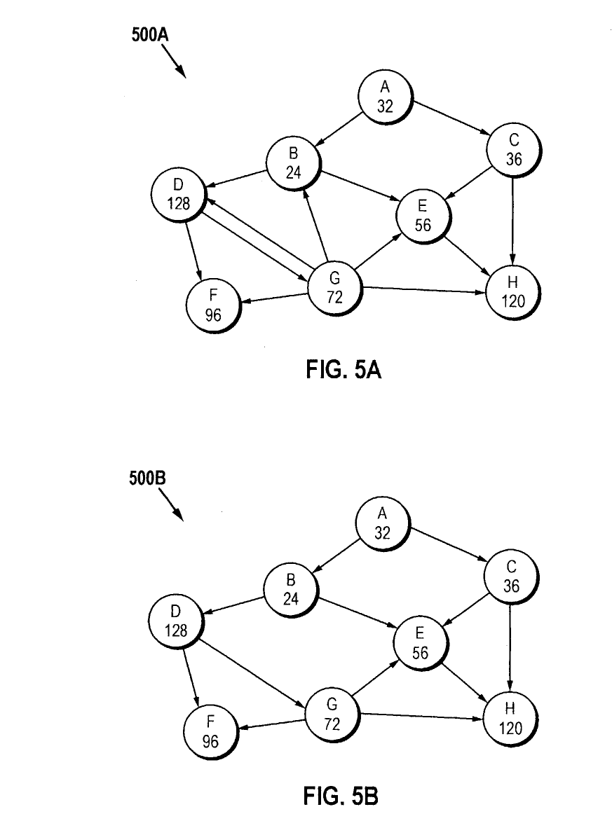

Referring contemporaneously to FIG. 5A and FIG. 5B, therein is illustrated an exemplary cyclic reference graph heap 500A and an exemplary acyclic reference graph heap 500B, respectively, of the same heap space. Objects or nodes A through H are depicted as circles and the references or edges therebetween are depicted as arrows. The size of each object is indicated within the circle. For example, object E has a size of 56 bytes and has three incoming references, edges BE, CE, and GE, and one outgoing reference, edge EH. Incoming edge BE, for example, indicates an object B has a reference pointing to object E. It should be appreciated that the illustrated heaps 500A and 500B are simplified for illustrative purposes and an actual heap would contain many more objects having many more references.

As illustrated, heap 500A includes one reference cycle among objects B, D, and G formed by the edges BD, DG, and GB. Initially, the DME may walk the heap using a depth-first-search algorithm that employs two markers for each node encountered. The first marker may indicate if the node has been processed by the DME and the second marker may indicate the traversal path. Initially, both markers are clear and the first marker may only change from “clear” to “marked” once and the second marker may dynamically change to represent the traversal path. Further illustrations of the effectuation of the first and second markers as well as further illustrations of the effectuation of the system and method described herein should be apparent to those skilled in the art.

Cycles are detected by verifying if a reference from a newly visited node leads to a node which is on the traversal path. In such a case, a cycle is present and the reference in question is removed from the graph. In the illustrated example, the depth-first-search algorithm searches in alphabetical order. Thus the visiting order is object A, object B, object D, and then object F. Object F is a leaf, i.e., an object that has no outgoing references or descendants. Since object F is a leaf, the Bc(t)=T equation presented hereinabove is employed to determine the value of the deallocatable memory constraint function Bc(t). Accordingly, the Bc(F)=96 since the size of object F is 96 bytes.

Since object F is a leaf, the DME backtracks to object D, and then progresses to object G. At object G, the traversal path comprises object A, object B, and object D. The reference GB leading from object G to object B is cyclical since object B is on the traversal path of object G. Accordingly as illustrated in FIG. 5B, the reference GB is removed, i.e. marked as being cyclical. Similarly, the reference GD is cyclical since object D is on the traversal path of object G. Accordingly as illustrated in FIG. 5B, the reference GD is removed.

Continuing with the visit to object G, object E is visited. From object E, object H (a leaf) is visited. Since object H has no outgoing references, the deallocatable memory function Bc(H)=120. The DME then backtracks to object E. Object E has no unvisited descendants, accordingly the equation Bc(t)=T+ΣBc(sⱼ)/eⱼ described above is employed since object E has descendants. In this instance, Bc(E)=T+ΣBc(sⱼ)/eⱼ=56+Bc(H)/3=56+120/3=96.

Similarly following the calculation of Bc(E), the DME backtracks to object G, which has no unvisited descendants. Accordingly, Bc(G)=T+ΣBc(sⱼ)/eⱼ=72+Bc(E)/3+Bc(F)/2+Bc(H)/3=180. As described, the deallocatble memory engine is performing a post-order weighted memory calculation so that for any given object in the heap, the memory calculations of the descendants of that object are performed prior to the memory calculation of the object. This expedites the calculation of Bc(t). For example, prior to calculating Bc(G), the memory calculations for object G's descendants, objects E, F, and H, had been performed.

Continuing with the illustrated example, the DME backtracks to object D which has no further unvisited descendants. Accordingly, Bc(D)=128+Bc(F)/2+Bc(G)/1=356. This process continues for objects B and A, after which the objects may be sorted in descending order by the values of the Bc(t) function as illustrated in the following Table 1.

TABLE 1
Descending Sort of Bc(t)

| | Number of | |
|---|---|---|
| Object | Incoming References | Bc(t) |
| A | 0 | 520 |
| B | 1 | 412 |
| D | 1 | 356 |
| G | 1 | 180 |
| H | 3 | 120 |
| E | 3 | 96 |
| F | 2 | 96 |
| C | 1 | 76 |

Once the objects are sorted in descending order by the value of the deallocatable memory function Bc(t), the deallocatable memory engine will select the L topmost entries from the table and calculate the actual values of the deallocatable memory function B(t). For example, L=4, and the deallocatable memory function B(t) is calculated for objects A, B, D, and G as indicated by the respective values of the B(t) function in the B(t) column in the following Table 2:

TABLE 2
Calculation of B(t)

| | Number of Incoming | | |
|---|---|---|---|
| Object | References | Bc(t) | B(t) |
| A | 0 | 520 | 444 |
| B | 1 | 412 | 320 |
| D | 1 | 356 | 296 |
| G | 1 | 180 | 72 |

Accordingly, the costly computation of B(t) takes place for only a subset of candidate lingering objects, the subset comprising {A, B , D, G}, of the heap as represented by the set comprising {A, B, C, D, E, F, G, H}. Hence, the systems and methods described herein provide an approach to finding lingering objects and optimizing the memory usage of software applications that is not computationally intensive and is easily scalable in production environments. The subset of candidate lingering objects comprising {A, B, D, G} may be presented as described in association with block 416 of FIG. 4.

Although the invention has been particularly described with reference to certain illustrations, it is to be understood that the forms of the invention shown and described are to be treated as exemplary embodiments only. Various changes, substitutions and modifications can be realized without departing from the spirit and scope of the invention as defined by the appended claims.

What is claimed is:

1. A method for determining deallocatable memory in a heap that includes a plurality of referenced objects, comprising:
determining a subset of objects based on a predetermined criterion; and
determining the amount of deallocatable memory associated with objects of said subset.

2. The method as recited in claim 1, comprising removing reference cycles associated with said plurality of references of objects to provide an acyclic subset of objects.

3. The method as recited in claim 1, comprising performing a weighted memory calculation to approximate the amount of deallocatable memory held by the referenced objects.

4. The method as recited in claim 1, wherein the operation of determining a subset of objects comprises applying a filter criterion that includes a “Constrained Bytes Held” metric.

5. The method as recited in claim 1, wherein the operation of determining the amount of deallocatable memory associated with objects of the subset comprises temporarily removing the object and nullifying all the references to the particular object.

6. The method as recited in claim 1, wherein the referenced objects are associated with an object reference graph created pursuant to executing a software application that is written in a computer language selected from the group consisting of Java, Eiffel, and C#.

7. A computer-readable medium operable with a computer to determine deallocatable memory in a heap that includes a plurality of referenced objects, the medium having stored thereon:
instructions for determining a subset of objects based on a predetermined criterion; and
instructions for determining the amount of deallocatable memory associated with objects of the subset.

8. The computer-readable medium as recited in claim 7, comprising instructions for removing reference cycles associated with said plurality of referenced objects to provide an acyclic subset of objects.

9. The computer-readable medium as recited in claim 7, comprising instructions for performing a weighted memory calculation to approximate the amount of deallocatable memory held by the referenced objects.

10. The computer-readable medium as recited in claim 7, wherein the instructions for determining a subset of objects comprise instructions for applying a filter criterion that includes a “Constrained Bytes Held” metric.

11. The computer-readable medium as recited in claim 7, wherein the instructions for determining the amount of deallocatable memory associated with objects of the subset comprise instructions for temporarily removing the object and nullifying all the references to the particular object.

12. The computer-readable medium as recited in claim 7, wherein the referenced objects are associated with an object reference graph created pursuant to executing a software application that is written in a computer language selected from the group consisting of Java, Eiffel, and C#.

13. A method for analyzing a heap for a subset of candidate lingering objects, comprising:
calculating the size of said heap;
traversing said heap;
for each object in said heap, removing reference cycles and performing a weighted memory calculation;
applying a filter criterion to said objects to create a subset of candidate lingering objects;
for each object in said subset of candidate lingering objects, temporarily removing said object and nullifying all references to that particular object;
determining the amount of deallocatable memory associated with said object in said subset of candidate lingering objects;
reinstantiating said object and its references; and
presenting said subset of candidate lingering objects.

14. The method as recited in claim 13, wherein said operation of traversing said heap comprises traversing said heap in a recursive depth-first fashion.

15. The method as recited in claim 13, wherein said operation of performing a weighted memory calculation comprises performing a post-order weighted memory calculation.

16. The method as recited in claim 13, wherein said operation of determining the amount of deallocatable memory associated with said object comprises performing a garbage collection operation.

17. The method as recited in claim 13, wherein said operation of presenting said subset of candidate lingering objects comprises presenting said subset of candidate lingering objects via a user-interface.

18. The method as recited in claim 17, wherein said heap is associated with an execution of a software application in a development environment.

19. The method as recited in claim 17, wherein said heap is associated with an execution of a software application in a production environment.

20. A computer-readable medium operable with a computer to analyze a heap for a subset of candidate lingering objects, the medium having stored thereon:
instructions for calculating the size of said heap;
instructions for traversing said heap;
for each object in said heap, instructions for removing reference cycles and performing a weighted memory calculation;
instructions for applying a filter criterion to said objects to create a subset of candidate lingering objects;
for each object in said subset of candidate lingering objects, instructions for temporarily removing said object and nullifying all references to that particular object;
instructions for determining the amount of deallocatable memory associated with said object in said subset of candidate lingering objects;
instructions for reinstantiating said object and its references; and
instructions for presenting said subset of candidate lingering objects.

21. The computer-readable medium as recited in claim 20, wherein said instructions for traversing said heap comprise instructions for traversing said heap in a recursive depth-first fashion.

22. The computer-readable medium as recited in claim 20, wherein said instructions for performing a weighted memory calculation comprise instructions for performing a post-order weighted memory calculation.

23. The computer-readable medium as recited in claim 21, wherein said instructions for determining the amount of deallocatable memory associated with said object comprise instructions for performing a garbage collection operation.

24. The computer-readable medium as recited in claim 22, wherein said instructions for presenting said subset of candidate lingering objects comprises instructions for presenting said subset of lingering objects in a user-interface.

25. The computer-readable medium as recited in claim 22, wherein said heap is associated with an execution of a software application in a development environment.

26. The computer-readable medium as recited in claim 22, wherein said heap is associated with an execution of a software application in a production environment.

27. A system for determining deallocatable memory in a heap that includes a plurality of referenced objects, comprising:
means for determining a subset of objects based on a predetermined criterion; and
means for determining the amount of deallocatable memory associated with objects of said subset.

28. A computer, comprising:
a heap structure including a plurality of referenced objects;
means for determining a subset of objects based on a predetermined criterion; and
means for determining the amount of deallocatable memory associated with objects of said subset.
